(19) United States
(12) Patent Application Publication
(10) Pub. No.: US 2007/0125720 A1
(43) Pub. Date: Jun. 7, 2007

(54) Decanter for reducing the level of carbon dioxide in alcoholic drinks and respective reduction method

(76) Inventor: Luigi Stecca, Costa di Rovigo (IT)

Correspondence Address: Harbin King & Klima, 500 Ninth Street SE, Washington, DC, 20003, US

(21) Appl. No.: 11/634,937

(22) Filed: Dec. 7, 2006

(30) Foreign Application Priority Data
Dec. 7, 2005 (EP) 05425871.0

(51) Int. Cl. B04B 3/00

(52) U.S. Cl. 210/781

(57) ABSTRACT

A decanter for consuming and tasting drinks such as beer has a plurality of raised ribs (11) inside it, extending from the base (12) towards the mouth (5) of the decanter (1) and evenly distributed radially or in a helical or spiral arrangement; a decanter (1) with such ribs (11), held at an angle during filling and rotated during and after filing, allows the drink to be subjected to a whirling motion, with consequent partial elimination of the carbon dioxide and enhancement of the organoleptic properties of the beer.

### BACKGROUND OF THE INVENTION

The present invention relates to a decanter for reducing the level of carbon dioxide in alcoholic drinks such as wine and beer and a method for reducing excess carbon dioxide in such drinks.

As is known, the term decanter or decantation carafe refers to a vessel used to oxygenate alcoholic drinks before they are poured into a tankard or glass for consumption. The decantation operation usually consists in allowing the drink poured from a bottle or tin, etc. to stand for a predetermined time in the decanter before being served.

However, in particular for beer, this technique allows neither oxygenation which suitably enhances the aromas and flavors, nor a noticeable reduction in the carbon dioxide.

As is known, carbon dioxide is spontaneously produced during beer fermentation. Additional carbon dioxide is then artificially added at the moment of bottling, to allow the product to be preserved for longer.

Therefore, obviously the need to reduce the amount of carbon dioxide dissolved in beer is considered even greater than for wine.

In conclusion, for both wine and beer there is a definite need for good oxygenation and reduction of the level of excess carbon dioxide contained in them, to achieve the beneficial effects described above, that is to say, limitation of the body's ability to absorb alcoholic products and enhancement of the aromas and flavors of the drinks.

### SUMMARY OF THE INVENTION

The aim of the present invention is, therefore, to overcome the above-mentioned disadvantages by providing a decanter comprising the characteristics described in claim 1 and a method for reducing the level of carbon dioxide in drinks such as beer, comprising the steps described in claim 11.

### BRIEF DESCRIPTION OF THE DRAWINGS

The technical characteristics of the invention, with reference to the above aims, are clearly described in the claims below and its advantages are more apparent from the detailed description which follows, with reference to the accompanying drawings which illustrate a preferred embodiment of the invention provided merely by way of example without restricting the scope of the inventive concept, and in which:

FIGS. 1 to 3 and FIG. 6 are perspective front views of several embodiments of the decanter in accordance with the present invention;

FIGS. 4 and 5 are scaled up perspective views of a detail of the decanters illustrated in FIGS. 1 and 6.

### DESCRIPTION OF THE PREFERRED EMBODIMENTS

With reference to the accompanying drawings, the numeral 1 denotes as a whole a decanter for consuming and tasting drinks such as wine and beer, consisting of a vessel 2 having the shape of an amphora, that is to say, with a rounded lower portion 3, a narrow neck 4 and a flared mouth 5.

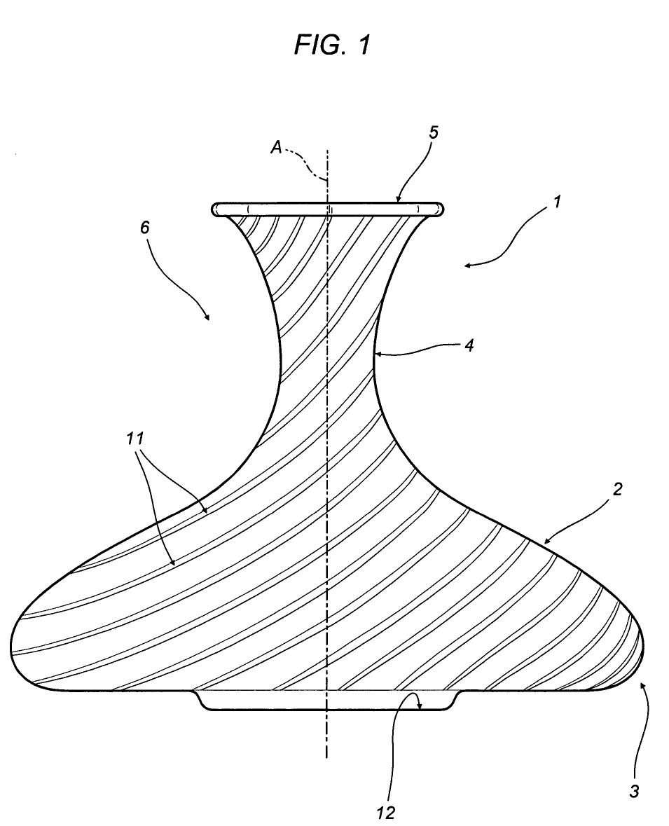

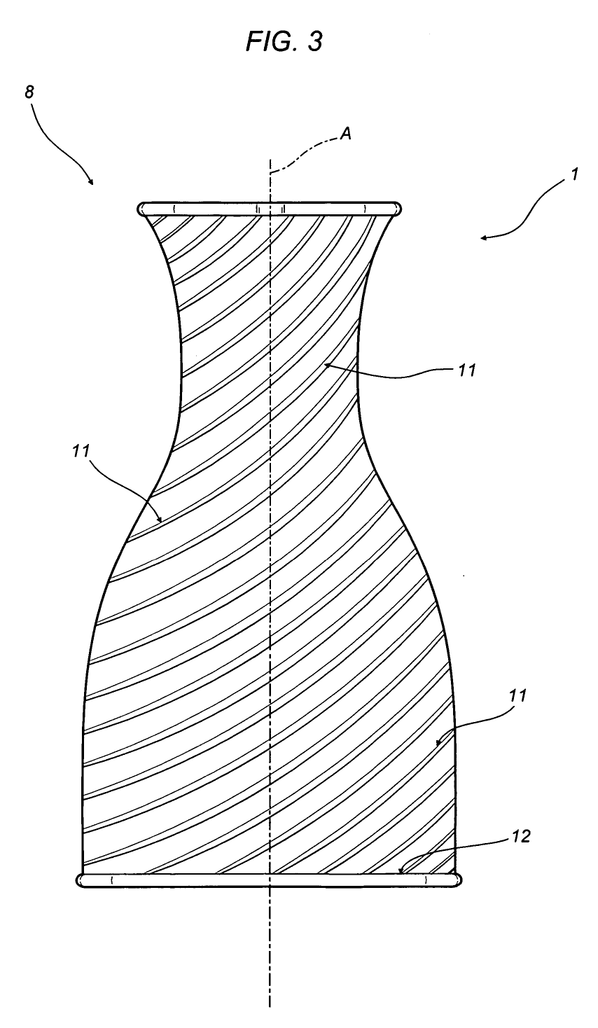

In particular FIGS. 1, 2, 3 and 6 illustrate different shaped decanters, labeled 6, 7, 8, and 9.

In accordance with the present invention, on their inner surface 10 the decanters have a plurality of raised ribs 11, evenly distributed and extending from the base 12 towards the mouth 5 of the decanters.

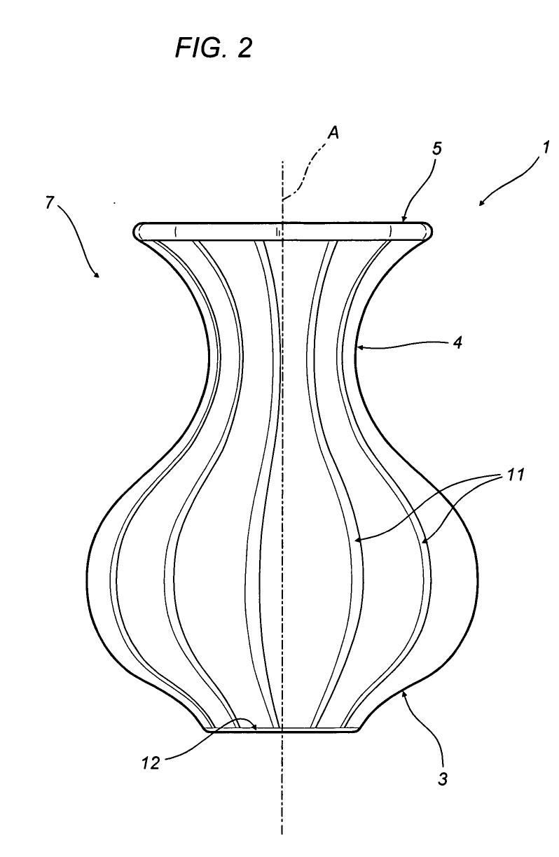

In particular in the decanter 7, illustrated in FIG. 2, said ribs 11 extend according to planes parallel with the axis A, whilst in the decanters 6, 8 and 9 the ribs 11 extend in a helical or spiral arrangement, in opposite directions to one another.

In particular as regards the decanter 9 in FIG. 6, the ribs 11 extend only partly from the base 12 over a predetermined section covering only a lower, substantially semi-spherical 13 portion.

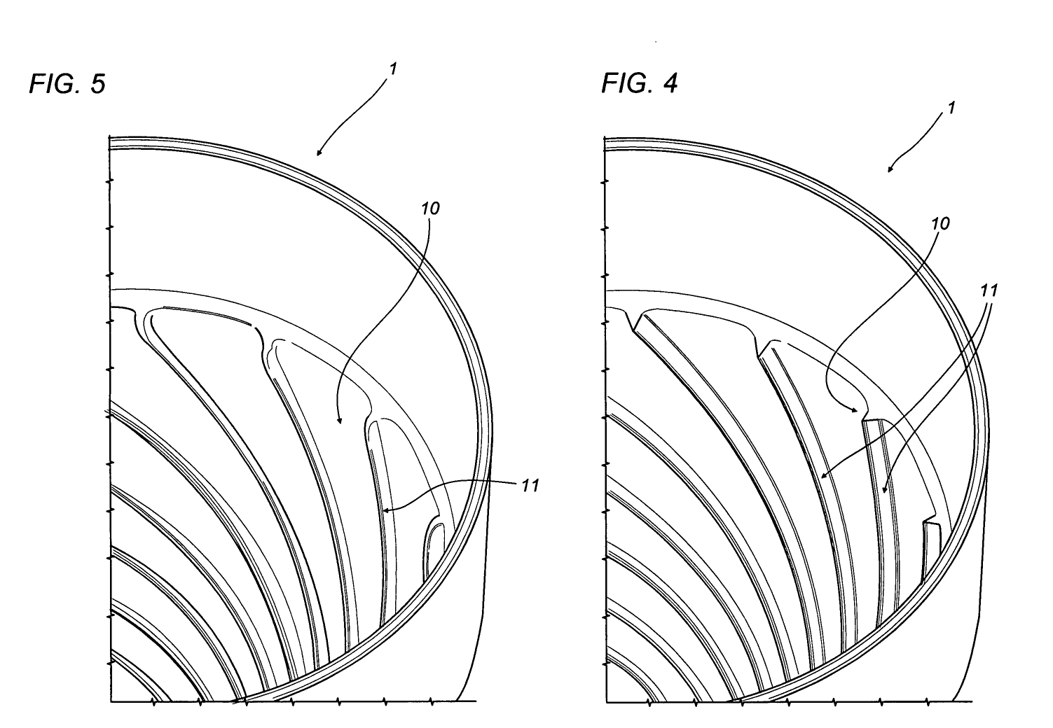

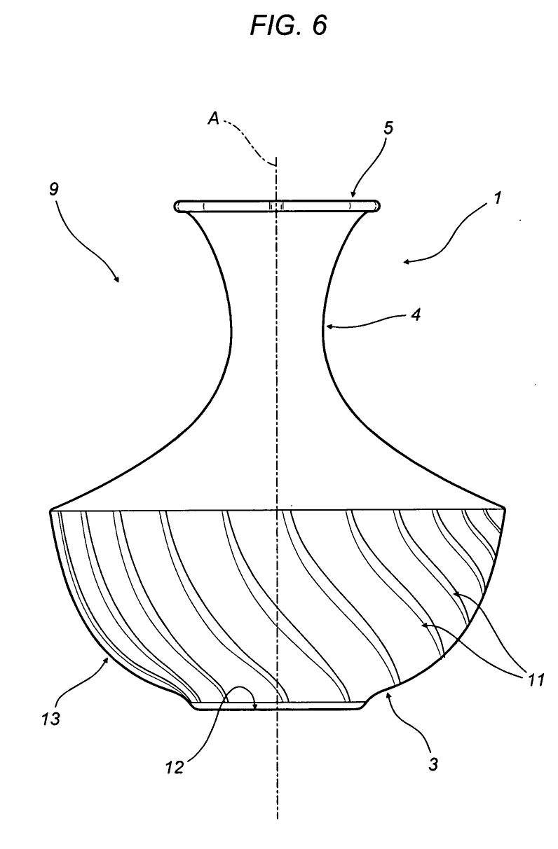

As illustrated in particular in FIGS. 4 and 5, the ribs 11 in cross-section have a rounded shape and differ in thickness.

The ribs 11 may also have a sharp-edged triangular shape and a polygonal shape forming two sharp edges.

In practice, the dimensions of the ribs 11 in cross-section are between 0.5 and 3.5 mm.

In use, in the case of beer, using any of the decanters 1 illustrated, while filling, the consumer holds the decanter 1 at an angle so that the flow of liquid is diverted by the ribs 11 with a whirling motion, which carries the carbon dioxide upwards.

Simultaneously and at the end of filing, the consumer makes the decanter 1 perform a series of rotations in order to generate, again thanks to the ribs 11, a turbulent beer motion which eliminates the excess carbon dioxide. However, said rotary motion does not alter the properties of the beer, instead enhancing its aromatic qualities and flavors.

After the rotary motion agitating step, the beer is left to stand in the decanter and is then served in glasses for tasting.

In the case of wine, using in particular a decanter 1 illustrated in one of the accompanying drawings, once it has been filled, the consumer rotates the decanter 1 so that the ribs 11 cause a turbulent motion with the aim of making the liquid absorb a predetermined quantity of air and as a result of oxygen.

This oxygen absorption enhances particular qualities of the wine such as its aromas and flavors.

Said oxygenation therefore enhances the organoleptic qualities of the wine and partly eliminates the carbon dioxide contained in it, which also helps to enhance the perfumes.

Finally, it should be noticed that another effect of the shape of the decanters 1 with the ribs 11 is, even in the case of wine, a slight reduction in the level of alcohol, since some alcohol tends to be released from the drink as a result of its whirling motion. Moreover, the motion of the wine in a decanter 1 made in accordance with the invention generates pleasant musical notes.

The invention described has evident industrial applications and can be modified and adapted in several ways without thereby departing from the scope of the inventive concept. Moreover, all technical details of the invention may be substituted by technically equivalent elements. For example, the decanters 1 can obviously be made with any shape and using any material.

1. A decanter for reducing the level of carbon dioxide in alcoholic drinks, wherein the decanter (1) has at least one raised rib (11) inside it.

2. The decanter according to claim 1, wherein the decanter (1) has a plurality of raised ribs (11) inside it.

3. The decanter according to claim 2, wherein the ribs (11) extend from the base (12) towards the mouth (5) of the decanter (1) and are evenly distributed.

4. The decanter according to claim 3, wherein the ribs (11) extend from the base (12) towards the mouth of the decanter (1) in a radial arrangement.

5. The decanter according to claim 3, wherein the ribs (11) extend from the base (12) towards the mouth (5) of the decanter (1) in a helical or spiral arrangement.

6. The decanter according to claim 5, wherein the ribs (11) are distributed in a first and a second set, extending in opposite directions.

7. The decanter according to claim 6, wherein the ribs (11) have at least one sharp edge in cross-section.

8. The decanter according to claim 7, wherein the ribs (11) have a triangular or polygonal shape in cross-section.

9. The decanter according to claim 6, wherein the ribs (11) have a rounded shape in cross-section.

10. The decanter according to claim 9, wherein the size of the ribs (11) is substantially between 0.5 and 3.5 mm.

11. A method for eliminating excess carbon dioxide from and for oxygenating drinks using a decanter (1) according to claim 10, comprising the step of rotating the decanter (1) during and/or after filling, thus allowing the ribs (11) to generate whirling and/or turbulent motion of the drink, consequently partly eliminating the carbon dioxide and enhancing the organoleptic properties of the drink.

12. The method according to claim 11, comprising a step of positioning the decanter (1) at an angle while filling it and rotating it to allow the ribs (11) to generate a whirling turbulent motion designed to promote the elimination of carbon dioxide.

13. A method for eliminating excess carbon dioxide from and for oxygenating drinks, comprising the following steps of gripping the decanter (1) which has a plurality of ribs (11) distributed inside it and which extend from the base to the mouth of the decanter, rotating the decanter (1) during and/or after filling, thus allowing the ribs (11) to generate whirling and/or turbulent motion of the drink, consequently partly eliminating the carbon dioxide and enhancing the organoleptic properties of the drink, pouring the drink into glasses for tasting.

14. The method according to claim 13, comprising the additional step of letting the drink stand in the decanter (1) for a predetermined time.

15. The decanter according to claim 2, wherein the ribs (11) extend from the base (12) towards the mouth of the decanter (1) in a radial arrangement.

16. The decanter according to claim 2, wherein the ribs (11) extend from the base (12) towards the mouth (5) of the decanter (1) in a helical or spiral arrangement.

17. The decanter according to claim 1, wherein the ribs (11) have at least one sharp edge in cross-section.

18. The decanter according to claim 1, wherein the ribs (11) have a rounded shape in cross-section.

19. The decanter according to claim 1, wherein the size of the ribs (11) is substantially between 0.5 and 3.5 mm.

20. A method for eliminating excess carbon dioxide from and for oxygenating drinks using a decanter (1) according to claim 1, comprising the step of rotating the decanter (1) during and/or after filling, thus allowing the ribs (11) to generate whirling and/or turbulent motion of the drink, consequently partly eliminating the carbon dioxide and enhancing the organoleptic properties of the drink.
